(19) United States
(12) Patent Application Publication
(10) Pub. No.: US 2024/0199962 A1
(43) Pub. Date: Jun. 20, 2024

(54) METHODS AND SYSTEMS FOR DEMULSIFICATION AND GENERATION OF PLASMA ENHANCED TREATMENT FLUIDS USING PLASMA

(71) Applicants: David Wragg, Gainesville, GA (US); Jamie Kraus, College Station, TX (US)

(72) Inventors: David Wragg, Gainesville, GA (US); Jamie Kraus, College Station, TX (US)

(21) Appl. No.: 18/085,172

(22) Filed: Dec. 20, 2022

(51) Int. Cl. C10G 33/02; B01D 17/04; B01J 19/08; B01J 19/12

(52) U.S. Cl. CPC C10G 33/02; B01D 17/04; B01J 19/088; B01J 19/12; B01J 2219/00853; B01J 2219/00927; B01J 2219/00934; C10G 2300/1033

(57) ABSTRACT

The invention is directed to systems, apparatus and methods for demulsifying an emulsion, and generating plasma enhanced treatment fluids, with at least one plasma reactor to produce plasma in reaction with the emulsion to cause flocculation and coalescence in the emulsion for phase separation of the constituents and chemical reaction with reactor fluids. After separation, the separated constituents in the emulsion are removed from the reaction chamber for processing of further emulsion. Plasma enhanced treatment fluids are removed from the reaction chamber and used in further processes. According to an example, the emulsion may be a crude oil emulsion with the separated crude oil produced for further processing or sale. The systems, apparatus and methods also produce plasma enhanced treatment fluids that may be reused in other oil recovery processes for example.

### TECHNICAL FIELD

The invention relates to demulsification and separation of constituents in an emulsion, for example, apparatus and methods for demulsifying crude oil emulsions or other similar emulsions, using plasma treatment. The invention also relates to forming plasma enhanced treatment fluids such as plasma enhanced treatment water and/or plasma enhanced treatment gas(es).

### BACKGROUND OF THE INVENTION

In various situations, different fluids become emulsified together when it is not desired to produce an emulsion, thereby requiring demulsification. For example, crude oil is generally found in association with gas and saline formation water in the ground. The oil, brine and gases become emulsified during oil production processes. Further, as the reservoir becomes depleted, enhanced oil recovery (EOR) methods may use water or steam, or gas(es) for example, which are injected into an oil reservoir and then coproduced with oil. The oil emulsions may thus comprise a large or varying percentage of oil or water or depending on the production process, but in each case result in a highly stable emulsion. The oil emulsions present a significant problem for oil producers. These immiscible fluids are readily emulsified by the simultaneous action of shear and pressure drop at the wellhead, chokes and valves and other mechanisms during oil production. The need for demulsification has also expanded in significance due to the usage of water, steam and/or gases, for flooding operations or in situ recovery of heavy oils for example.

In general, crude oil emulsions are stabilized by rigid interfacial films that form a “skin” on water droplets and make it more difficult for the droplets to coalesce. The stability of these interfacial films, and hence, the stability of the emulsions, depends on a number of factors, including the heavy material in the crude oil (e.g., asphaltenes, resins, and waxes), solids (e.g., clays, scales, and corrosion products), temperature, droplet size and droplet-size distribution, pH, and oil and brine composition for example. Produced oil generally has to meet company and pipeline specifications. For example, the oil shipped from wet-crude handling facilities may be specified to not contain more than 1% basic sediment and water (BS&W) and 10 pounds of salt per thousand barrels of crude oil. Low BS&W and salt content is required to reduce corrosion and deposition of salts, which can damage or be detrimental effects to refinery or other equipment. Current separators and desalters have a high capital cost and also require high retention times, particularly with low API or heavy oils and in water or steam flooding operations. For example, enhanced oil recovery (EOR) uses water flooding, while oil sands may use steam-assisted gravity drainage (SAGD) operations in producing heavy oils. In such examples, in the field downstream of the well head, crude oil, water, and solids are produced together and flow in surface piping toward a facility tank resulting in severe emulsions. The heavier the crude oil, the worse the emulsion. Heavy oil operators currently experience retention times for heavy crude oil and water separation using traditional methods in the field of 3 days to up to a month. In another example, a typical SAGD operation may have a desalter with a 100,000 bpd throughput capacity, but this also results in ˜5% by volume developing into a rag layer where the operators are forced to purge off and inject to ensure steady production. This adds an operating expense and is wasteful, as this ˜5% by volume rag layer can contain up to half its volume in crude oil.

The breaking of emulsions during oil production is a costly problem, both in terms of chemicals or energy used, production lost and other problems. This process is generally accomplished by techniques including adding chemical demulsifiers, increasing the temperature of the emulsion, applying electrostatic fields that promote coalescence of water in the emulsion and/or reducing the velocity or stopping the flow of the emulsion that allows gravitational separation of oil, water, gases and solids. Some oil separators termed electrostatic coalescers apply an electric field to the emulsion, polarizing the oil and water droplets in the emulsion to attempt to cause flocculation and coalescence. However, the use of high voltages poses a danger as it may result in ignition of the hydrocarbon material or other problems. Additionally, existing traditional electrostatic coalescers, such as the Schlumberger NAPCO, are very large in scale and high in cost, and thus are only usable at large scale production sites. Further, current demulsification methods are application specific because of the wide variety of crude oils, brines, separation equipment, chemical demulsifiers, and product specifications. As emulsions and conditions generally change over time, this adds to the complexity of the demulsification treatment.

Oil emulsions can also occur in other situations, such as crude oil spills in bodies of water and/or washed up onto beaches. The longer the time the oil spill cleanup takes, the larger the impact on the environment. Though techniques have been developed to remove such contaminants, these have various associated problems. For oil impacted soils and solids, soil washing techniques are typically employed.

Accordingly, it would be desirable to provide apparatus and methods for demulsification of emulsions, such as crude oil emulsions, which overcome the problems associated with current techniques. For example, it would be desirable to provide apparatus and methods for demulsification of emulsions at a faster rate or speed. It is also desired to achieve the desired separation of constituents in the emulsion to <1% BS&W, and to increase production throughput without needing large and high capital cost equipment and energy input, the cost of chemicals, or other costs or problems as compared to traditional apparatus and methods.

### SUMMARY OF THE INVENTION

The apparatus, systems and methods of the invention are directed to overcoming limitations or problems with demulsification of crude oil emulsions or the like. The systems and methods of the invention reduce the need for long retention time to phase separate emulsions. The invention also reduces or eliminates the need for chemical demulsifiers, increasing the temperature of the emulsion or the like, though such techniques may be used in combination with the invention. For crude oil, the systems and methods also reduce the need for blending of condensate with the separated crude oil to satisfy pipeline specifications for example. The systems and methods of the invention provide the ability to produce more oil more quickly, while not requiring significant capital expenditure or space to achieve demulsification. The systems and methods of the invention also allow for enhanced production from oil reservoirs by forming plasma enhanced treatment fluids having synthesized surfactants and demulsification or other reactive molecules or species, that can be used in waterflooding, gas flooding, downhole applications or other oil recovery or related processes for example. The apparatus, systems and methods of the invention may also be used with other types of emulsions that may require demulsification, and the plasma enhanced treatment fluids useful for other processes or applications. These and other advantages are described in relation to various examples.

According to an example, the invention is directed to a method of demulsifying an emulsion comprising providing at least one plasma reactor with a reactor body defining a reaction chamber. The reaction chamber is filled with a carrier gas, and an emulsion is introduced into the chamber. At least one pair of electrodes are positioned in the reaction chamber and are energized to a voltage to ionize the carrier gas and produce plasma in the reaction chamber to cause flocculation and electrostatic coalescence in the emulsion for separation of the constituents in the emulsion. The separated constituents in the emulsion are removed from the reaction chamber. According to an example, the emulsion is introduced into the reaction chamber as a stream and continuously flows through the reaction chamber to at least one outlet port. Alternately, the treatment of the emulsion may be done in a semi-continuous/intermittent manner or in batches. The emulsion may be an oil emulsion with at least oil and water constituents, and the separated oil and water constituents are removed through at least one outlet port from the reaction chamber. For example, oil and plasma enhanced treatment water removed from the emulsified mixture may be pumped from separate outlet ports of the reactor body to separate storage tanks or otherwise. The oil may be pumped for further processing or sale, and the plasma enhanced treatment water may be reused in oil recovery or other processes for example. The plasma enhanced treatment gas(es) may be recirculated to the at least one reactor or removed for use in another process or application.

In another example, the invention is directed to a method of producing water treatment fluids for use in oil recovery methods comprising providing at least one plasma reactor with a reactor body defining a reaction chamber. The reaction chamber is filled with a carrier gas, and a crude oil/water emulsion is introduced into the chamber. At least one pair of electrodes are positioned in the reaction chamber and are energized to a voltage to ionize the carrier gas and produce plasma in the reaction chamber. The plasma energy reacts with the surface and volume of the emulsion, such as a crude oil/water emulsion, and transfers a charge to the crude oil/water emulsion to establish an electric field in the oil/water emulsion to cause flocculation and coalescence of constituents, as well as produce synthesized surfactants and demulsification molecules in association with the reactor fluids, to generate plasma enhanced treatment fluids. The plasma treatment of an oil emulsion for example produces plasma enhanced treatment water and/or plasma enhanced treated gas(es). The plasma enhanced treatment water or gas(es) are separated and removed from the reaction chamber for use in other processes. In an example, the plasma treated or enhanced treatment water may be recirculated into the at least one reactor of a demulsification system of the invention, injected into an oil reservoir in a waterflooding operation, or for another process or application. Similarly, the plasma enhanced treatment gas(es) may be used in other demulsification processes, gas lifting operations or other processes. The plasma enhanced treatment fluids may have enhanced wettability in relation to the formation and facilitate oil recovery operations. The enhanced wettability facilitates interactions between the solid rock or other solids and the liquids in a reservoir, such as the crude oil and brine that displace the oil to be produced. The carrier gas is ionized by the at least one pair of electrodes to produce plasma energy that causes chemical reactions with the reactor fluids, to produce synthesized surfactants and demulsification or other molecules in association with the reactor fluids. The amount of plasma energy can be varied, and use of a non-oxidative carrier gas may allow for higher electric fields to be produced in the emulsion, to generate plasma enhanced treatment fluids useable in other processes. The plasma energy chemically alters the emulsion mixture, and fluids such as water and/or gas(es) in the emulsion or introduced into the reactor. The plasma enhanced water and plasma enhanced gas(es) may thus have enhanced demulsifying characteristics, enhanced wettability and surfactant properties, and anti-microbial properties. The plasma energy causes reaction of the energy with the fluids, to synthesize larger surfactant and demulsification molecules to produce plasma enhanced water and plasma enhanced gas(es). The plasma energy may thus create plasma enhanced gas(es) with radicals and/or ions in the gas phase headspace above the emulsion and/or polymerization of gas(es), that go on to interact with the liquids and dissolve and become solvated, to enhance reactivity of electrons and/or ions in the liquids to facilitate flocculation and coalescence in the emulsion and create the plasma enhanced treatment fluids for example. The plasma energy results in chemically altering the liquids including the water to form plasma enhanced treatment water for example. The plasma enhanced treatment fluids, such as water and/or gas(es), may then be usable in other processes, with the plasma enhanced characteristics facilitating further demulsification processes, waterflooding or gas flooding processes or for many other possible processes and/or applications. With respect to an oil emulsion, the improved demulsification properties, enhanced wettability and surfactant properties, anti-microbial properties and other enhanced properties are useful in further oil recovery processes. These enhanced properties may also form treatment fluids that are specific to the particular oil reservoir and oil emulsion being demulsified, but may be usable with any oil reservoir or emulsion. The plasma enhanced treatment water and/or gas(es) with synthesized surfactant, wettability and demulsification molecules may then be beneficially used for EOR or downhole applications, lifting operations or other processes. For example, the plasma enhanced water and/or gas(es) may be used in flooding operations to promote removal and production of oil from a reservoir in which the treatment fluids are injected, to facilitate fracking operations, to facilitate gas lifting operations or for any other desired process or purpose.

In another example, the invention is directed to a method of demulsifying a rag layer formed in oil recovery operations, comprising providing at least one plasma reactor with a reactor body defining a reaction chamber. The reaction chamber is filled with a carrier gas, and a rag layer is introduced into the chamber. At least one pair of electrodes are positioned in the reaction chamber and are energized to a voltage to ionize the carrier gas and produce plasma in the reaction chamber that causes flocculation and electro-coalescence in the rag layer for separation of the oil and water constituents in the rag layer. The separated constituents in the emulsion are removed from the reaction chamber. According to an example, the rag layer is removed from a source and introduced into the at least one reaction chamber as a stream and continuously flows through the reaction chamber to at least one outlet port. The emulsion may be a crude oil emulsion with at least oil and water constituents, and the separated oil and water constituents are removed through at least first and second outlet ports from the reaction chamber. For example, oil and water removed from the emulsified mixture may be pumped from separate outlet ports of the reactor body. The oil may be pumped for further processing or sale, and the plasma enhanced treatment fluids may be reused in enhanced oil recovery (EOR) processes for example or other processes or applications.

A demulsifying system according to an example comprises at least one plasma reactor with a reactor body defining a reaction chamber. The reaction chamber includes a first gas inlet for supplying a carrier gas into the reaction chamber, and an emulsion inlet to introduce an emulsion into the chamber. At least one pair of electrodes are positioned in the reaction chamber, and a power supply is provided to supply a voltage to the at least one pair of electrodes to cause ionization of the gas and produce plasma in the reaction chamber. A separator is positioned in the reaction chamber to separate the produced constituents of the emulsion, and at least one outlet to remove the separated constituents of the emulsion from the reaction chamber. One or more outlet ports may be provided to remove the crude oil, water and any solids.

The demulsifying system may treat an emulsion in a continuous manner as a stream introduced into the reaction chamber, such as at a predetermined flow rate, with the separated constituents removed as they are produced. For example, the emulsion may be crude oil including water, or crude oil mixed with water and solids. The apparatus, systems and methods of the invention are usable to separate constituents of an emulsion, such as crude oil, water, and solid phases, such that re-emulsification is prevented. According to examples of the methods and apparatus, the voltage applied to the at least one pair of electrodes causes ionization of the gas to produce plasma, and may be at or in excess of the breakdown voltage of a carrier gas introduced into the reaction chamber through the first gas inlet. The carrier gas may be supplied to the reactor in a recirculating stream in association with at least one gas outlet, to maintain a predetermined pressure or pressure range in the reaction chamber. For oil emulsions, a non-oxidative gas may be used, which may be supplied from an oil well or any other source. The apparatus of the invention can run at standard conditions without inducing formation of a foam or rag layer. The separator may be any suitable separator to separate the immiscible liquids and solids formed in the reaction chamber. The apparatus and systems of the invention may be provided as relatively small, modular systems allowing easy transport and positioning in relation to a source of an emulsion, and require low maintenance.

These and other methods, processes, structures, apparatus, systems, characteristics, attributes, features and the like of the invention will be understood more fully upon a reading and understanding of various examples as set forth below.

### BRIEF DESCRIPTION OF THE DRAWINGS

FIG. 1 is a flow chart showing a method of demulsification according to an example of the invention.

FIG. 2 is a flow chart showing another method according to an example of the invention.

FIG. 3 is a flow chart showing another method according to an example of the invention.

FIG. 4 is a flow chart showing another method according to an example of the invention.

FIG. 5 is a flow chart showing another method according to an example of the invention.

FIG. 6 is a flow chart showing another method according to an example of the invention.

FIG. 7 shows a schematic of a plasma reactor according to an example of the invention.

FIG. 8 shows a schematic of a plasma reactor according to another example of the invention.

FIG. 9 shows a schematic of an oil recovery operation including one or more plasma reactor systems according to an example of the invention.

FIG. 10 shows a schematic of a demulsification system for downhole treatment of crude oil emulsions according to an example of the invention.

### DETAILED DESCRIPTION OF THE INVENTION

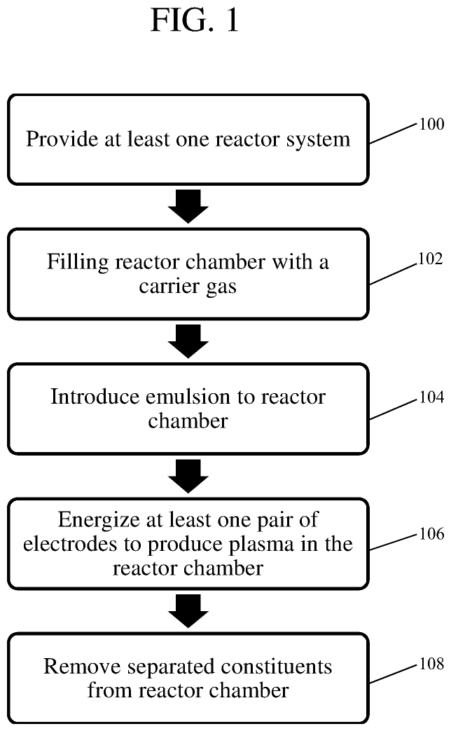

Examples of the invention will be described in relation to the treatment of oil in water (O/W) and/or water in oil (W/O) emulsions, such as are encountered in crude oil production operations, whether primary, secondary and/or other environments or applications. It should be understood that other emulsions, such as wastewater emulsions, gaseous emulsions or the like, may be treated with the apparatus, systems or methods of the invention in a similar manner. Emulsions are formed when at least two immiscible liquid phases are present within a system. In O/W or W/O emulsions, these unmixable fluids are emulsified by the simultaneous action of shear and pressure reduction at the head of the well, clogs, controller valves or various other aspects of oil production or recovery. Turning to FIG. 1, a flow chart of a method of demulsifying an emulsion is shown. The method includes providing at least one plasma reactor with a reactor body defining a reaction chamber at 100. The reaction chamber is filled with a carrier gas at 102 and an emulsion is introduced into the reaction chamber at 104, but these steps do not have to be performed in this sequence. In the example of an oil emulsion produced at an oil field, the carrier gas could be a gas produced with the oil emulsion, such as methane, flue gas generated at a refinery, or from any other source for example. At least one pair of electrodes are positioned in the reaction chamber and are energized to a voltage at 106 to ionize the carrier gas and produce plasma in the reaction chamber to cause flocculation and electrostatic coalescence in the emulsion for separation of the constituents in the emulsion. The separated constituents in the emulsion are removed from the reaction chamber at 108. According to an example, the emulsion is introduced into the reaction chamber as a stream and continuously or intermittently flows through the reaction chamber to at least one outlet port (which may also be the inlet port). Alternately, the treatment of the emulsion may be done in batches. The system and methods may also be used in other applications and environments as will be described with reference to examples. This may include wastewater handling from hydraulic fracturing (fracking) operations, in defoaming operations, desalters or other applications or environments. This may also include generation of plasma enhanced treatment fluids for use in various processes and/or applications, as will be described in more detail.

In an example, an oil field generally will include a plurality of oil wells in relation to an oil reservoir or source. For processing of the production from each well, the invention contemplates that all production wells or a group of production wells will be pumped to one or more central distribution systems that would bring together the emulsions from each well. The emulsion may then be supplied in a controlled manner to at least one demulsification system of the invention. The demulsification system of the invention is configurable to handle demulsification of the expected production rate of the oil field, and shouldn't be a limiting factor in production from the field, as significant settling or dwell times to separate constituents of the emulsion are generally not required. The demulsification system of the invention includes at least one plasma reactor for treatment of the emulsion. In an example, a plurality of relatively small modular reactors may each be designed to operate together to accommodate a predetermined flow rate of emulsion in a continuous demulsification operation in relation to a particular oil field or reservoir or other source of emulsion. One or more modular reactors can be mounted on a base, such as a pallet vehicle, ship or the like, to allow for easy transport and delivery to any site, such as an oil field, off shore platform, or any other production site. Any number of reactors can thus be positioned in close proximity to a source of emulsion. Such modular reactors may thus be implemented easily to handle a particular oil field's requirements or to process another source of emulsion. As the modular reactors are also relatively small and thus have a relatively small footprint, this allows implementation in any desired location in an oil field or otherwise.

For example, at least one demulsification system may be provided, with at least one plasma reactor, and used in association with onshore or offshore oil and gas production. The modular configuration provides a system sized to be implementable on an offshore oil production platform for example. Compared with prior methods, the use of one of more plasma reactors designed to handle the production from the one or more wells may be implemented at a lower capital cost as well as lower ongoing operational and maintenance costs. The apparatus, system and methods avoid the high capital cost of some types of equipment, such as large electrostatic coalescers, and have a significantly smaller footprint. The modular configuration also allows for operation of a plurality of reactors in parallel or in series, such that depending on the characteristics of the emulsion, there can be multiple stages of reactors in series. It is also possible to operate reactors separately, such that depending on the characteristics of the emulsion, a first stage reactor may be used to initiate phase separation of an emulsion with a first flow rate, energy input, pressure and/or other operational characteristics, while a second or further stage may use a different flow rate, energy input, pressure and/or other operational characteristics, to ensure a <1% BS&W phase separation in the crude oil emulsion for example. As will be described, the plasma energy and plasma density produces desired demulsification of an emulsion, and also produces plasma enhanced treatment fluids, including plasma enhanced treatment water and plasma enhanced treatment gas or gases for example. The plasma causes chemical reactions in and between gas and liquid molecules, which may then react with other constituents and molecules in the emulsion to produce new species having enhanced characteristics.

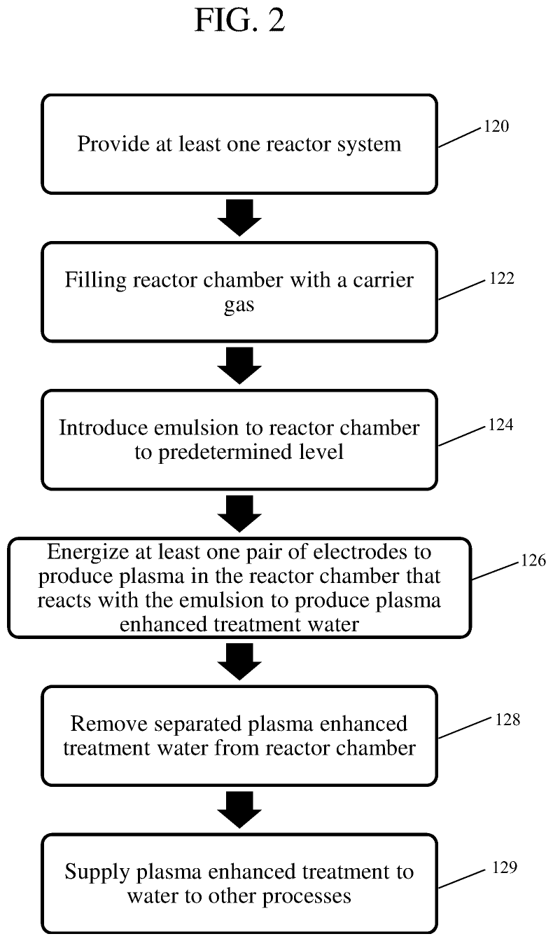

Turning to FIG. 2, a flow chart of another method for producing plasma enhanced treatment water or water treatment liquids for use in further processes such as oil recovery methods, comprises providing a treatment system with at least one plasma reactor at 120 with a reactor body defining a reaction chamber. The reaction chamber is filled with a carrier gas, at 122 and an emulsion including water for treatment, such as an oil/water emulsion, is introduced into the chamber at 124, but these steps do not have to be performed in this sequence. At least one pair of electrodes are positioned in the reaction chamber and are energized at 126 to a voltage to ionize the carrier gas and produce plasma in the reaction chamber that reacts with the at emulsion to produce plasma enhanced treatment water including synthesized chemicals, molecules, surfactants and/or demulsification molecules in association with the water. The plasma enhanced treatment water is separated from other constituents of the emulsion and removed from the reaction chamber at 128. The plasma enhanced treatment water is then introduced into oil production or other processes at 129, such as to enhance demulsification of oil/water emulsions produced in oil production processes or from spills on land or in the water, or other processes. The plasma enhanced treatment water may be recirculated and added in the demulsification reactor 120 of the invention if desired. Another alternative for example, as will be described in more detail below, may utilize the plasma enhanced treatment water in waterflooding operations used in generating further oil recovery from an oil field. Waterflooding is the use of water injection to increase the production from oil reservoirs. The injection of water may be to increase the reservoir pressure to its initial level and maintain it near that pressure. The water displaces oil from the pore spaces, but the efficiency of such displacement depends on many factors (e.g., oil viscosity and rock characteristics). During a waterflood operation in an oil field during EOR operations for example, an expected mixture of crude oil and water, such as 20/80%, is produced from the oil wells in the field. The volumetric recovery of oil during waterflooding may be increased by the use of the plasma enhanced treatment water in the waterflooding operation at standard conditions. The plasma treatment produces plasma enhanced treatment water with miscible surfactants and demulsification or other molecules in the water which in conjunction with displacement, tend to act as a solvent for the crude oil to enhance volumetric recovery of oil from the field and more effective separation of the constituents. Use of water injection processes may facilitate displacement of oil from pore spaces and rock surfaces, as it may have enhanced wettability in relation to the formation and facilitate oil recovery operations. The enhanced wettability facilitates interactions between the solids, rock and the liquids in a reservoir, such as the crude oil, brine and other materials. The volumetric recovery of oil during waterflooding may be increased by the use of the plasma enhanced treatment water in the flooding operation at standard conditions. The plasma treatment produces miscible surfactants and demulsification or other molecules in the water which in conjunction with displacement, tend to act as a solvent for the crude oil to enhance volumetric recovery of oil from the field. Plasma enhanced treatment water may also be used in association with other processes or to avoid the requirement for fresh or saltwater disposal from oil production processes such as hydraulic fracturing (fracking) processes or other applications. In a fracking operation for example, wastewater disposal is a significant cost, and any oil in the wastewater is not recovered. The use of plasma enhanced treatment water may allow recovery of the oil and reuse of the wastewater. The plasma enhanced treatment water may also work in synergy with fracking chemicals to provide enhanced oil recovery in a fracking operation for example. The ability to treat water in an emulsion or in conjunction with other constituents using the at least one reactor 120 to form plasma enhanced treatment water, allows such plasma enhanced treatment water to be reused where it otherwise may not be. The system may thus be used to produce plasma enhanced treatment water that is then usable to enhance constituent recovery, replace other treatment materials, avoid disposal problems or the like.

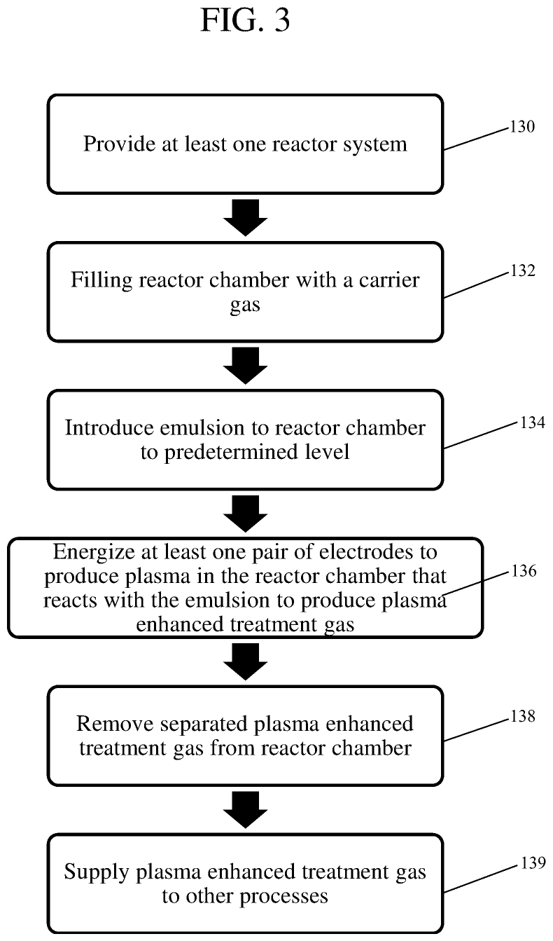

Turning to FIG. 3, a flow chart of another method for producing plasma enhanced treatment gas or gases for use in further processes such as demulsification processes, oil recovery processes or other processes using a gas or gases. This method comprising providing at least one treatment system with at least one plasma reactor at 130 with a reactor body defining a reaction chamber. The reaction chamber is filled with a carrier gas at 132 and an emulsion or other liquid is introduced into the chamber at 134, but these steps do not have to be performed in this sequence. At least one pair of electrodes are positioned in the reaction chamber and are energized at 136 to a voltage to ionize the carrier gas and produce plasma in the reaction chamber that reacts with the emulsion or other liquid or gas in the reactor fluids, for example the water and gases in an oil emulsion, to produce plasma enhanced treatment gas(es). The plasma enhanced treatment gas(es) may include synthesized surfactants and/or demulsification molecules and/or other reactive species that may be useful in association with oil recovery or other processes for example. The plasma treated and enhanced gas(es) is separated and removed from the reaction chamber at 138. The plasma enhanced treatment gas is then introduced and usable in other processes, such as oil recovery processes, at 139. Such plasma enhanced treatment gas(es) may be used for example to enhance demulsification of oil/water emulsions produced in oil production processes. In another example, as will be described in more detail below, waterflooding or gas flooding operations may be used in generating further oil recovery from an oil reservoir. Gas flooding is the use of gas injection to increase the production from oil reservoirs. Use of gas injection may facilitate displacement of oil from pore spaces and rock surfaces, as it may have enhanced wettability in relation to the formation and facilitate oil recovery operations. The enhanced wettability facilitates interactions between the solids, rock and the liquids in a reservoir, such as the crude oil and brine. The volumetric recovery of oil during gas flooding may be increased by the use of the plasma enhanced treatment gas in the flooding operation at standard conditions. The plasma treatment produces miscible surfactants and demulsification molecules in the gas(es) which in conjunction with displacement, tend to act as a solvent for the crude oil to enhance volumetric recovery of oil from the field. The plasma enhanced treatment gas(es) may also facilitate operations such as fracking operations in use with fluids and/or chemicals introduced into the formation during fracking. The production of plasma enhanced treatment gas(es) may be in conjunction with the formation of plasma enhanced treatment water as described with reference to FIG. 2. The use of such plasma enhanced treatment fluids in further oil recovery processes such as waterflooding or gas flooding for example, allows the concentration of radical or ion species, synthesized surfactant and/or demulsification molecules within plasma enhanced treatment water and/or gas(es) to be increased or multiplied as the plasma enhanced treatment fluids are used in further processes and then retreated using the at least one reactor system of the invention.

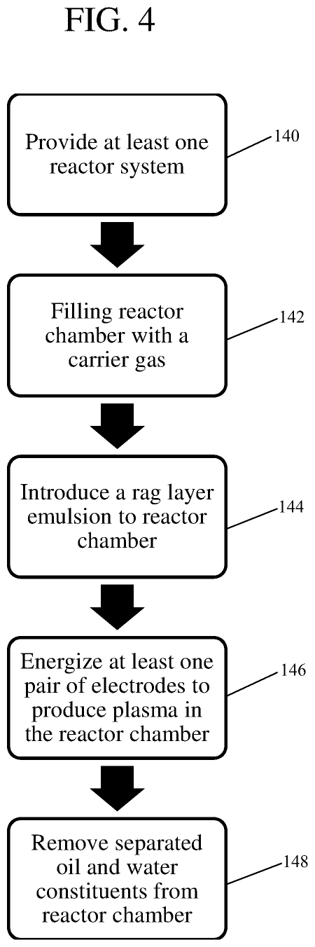

Turning to FIG. 4, a flow chart of a method of demulsifying a rag layer formed in oil recovery operations, comprising providing at least one plasma reactor at 140 with a reactor body defining a reaction chamber. The reaction chamber is filled with a carrier gas at 142 and a rag layer is introduced into the chamber at 144, but these steps do not have to be performed in this sequence. At least one pair of electrodes are positioned in the reaction chamber and are energized to a voltage at 146 to ionize the carrier gas and produce plasma in the reaction chamber that causes flocculation and electrostatic coalescence in the rag layer for separation of the oil and water constituents in the rag layer. The separated constituents in the emulsion are removed from the reaction chamber at 148. According to an example, the rag layer is removed from a source and introduced into the at least one reaction chamber as a stream and continuously flows through the reaction chamber to at least one outlet port. The rag layer emulsion may be a crude oil emulsion with at least oil and water constituents, and the separated oil and water constituents are removed through at least first and second outlet ports from the reaction chamber. For example, oil and water removed from the emulsified mixture may be pumped from separate outlet ports of the reactor body. The oil may be pumped for further processing or sale, and the plasma enhanced treatment fluids may be reused in enhanced oil recovery (EOR) processes for example.

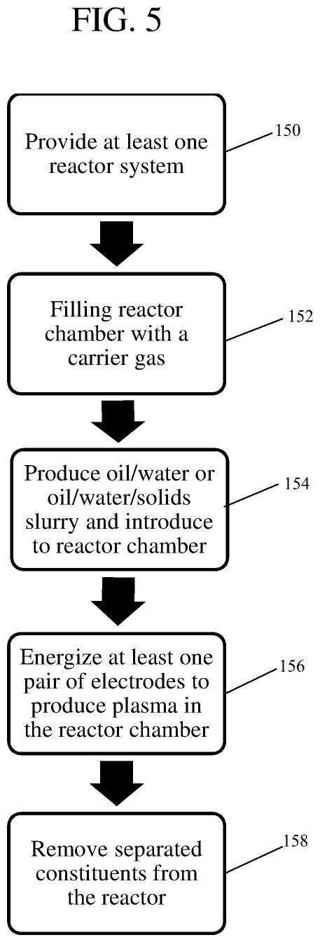

In another example, one or more demulsification systems may be used to assist in cleaning up a crude oil spill in water or on land such as from underwater or land based pipelines, well blowouts, barge or carrier accidents or otherwise. At the location of such a spill, a slurry pump or the like may be used to gather the oil/water emulsion from the water or oil in earthen materials combined with water and supply it to one or more demulsification systems of the invention. Turning to FIG. 5, a flow chart of a method of demulsifying a slurry of oil/water or oil/water/solids in spill mitigation and/or oil recovery operations such as oil sands, comprising providing at least one demulsification system with at least one plasma reactor at 150 with a reactor body defining a reaction chamber. The reaction chamber is filled with a carrier gas at 152, which may be a non-oxidative gas. An oil/water or oil/water/solids slurry produced and is introduced into the chamber at 154, but these steps 152 and 154 do not have to be performed in this sequence. At least one pair of electrodes are positioned in the reaction chamber and are energized to a voltage at 156 to ionize the carrier gas and produce plasma in the reaction chamber that causes flocculation and electrostatic coalescence in the slurry for separation of the oil, water and solids constituents in the slurry. The separated constituents in the emulsion are removed from the reaction chamber at 158. According to an example, an oil spill in water is removed from the water by a suitable system, such as a slurry pump, from a source and introduced into the at least one reaction chamber as a stream that continuously or intermittently flows through the reaction chamber to at least one outlet port. The oil/water or oil/water/solids slurry may be a crude oil with at least water mixed to some degree, and the separated oil and water constituents are removed through at least one outlet port from the reaction chamber. For example, oil and water removed from the slurry may be pumped from separate outlet ports of the reactor body for storage further processing or sale, and the water and/or solids removed for further processing or use. After separation, the oil can be salvaged, and supplied to a suitable storage location, while the plasma enhanced treatment water is storable for further use if needed. The use of one or more reactors aboard a vessel would be easily implemented for remediation of such spills in water for example, and reduce the environmental impact. Alternatively, the water/oil mixture could be supplied to onshore processing facility if desired. Similarly, the invention could be used in clean up of oil from beaches or soil affected by a spill along a pipeline or other location. The contaminated sand or soil with crude oil may be formed into a slurry with water, and can be pumped into one or more reactors where the crude oil, water, and solids can be phase separated. Similarly, heavy oil sands, may be produced more effectively by formation of a slurry supplied to one or more reactors where the crude oil, water, and solids can be phase separated. Processing in this or other examples with the at least one plasma reactor of the invention may also provide at least partial desalting of water in the emulsion. The possible smaller, modular configuration of the reactors may also allow for separation farther upstream from a source of emulsion, which may improve transportation and production efficiencies in various situations or applications.

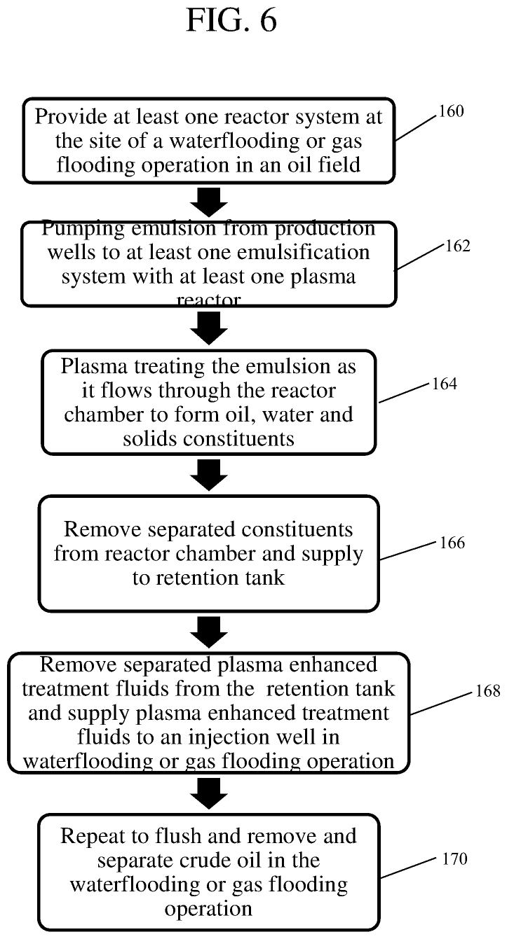

Turning to FIG. 6, a flow chart of a method of producing crude oil in a waterflooding and/or gas flooding operation is shown. In many oil fields, further oil production is facilitated by waterflooding and/or gas flooding, in which water and/or gas is pumped into the ground in an oil field through an injection well. The pumping of water and/or gas increases the production from oil reservoirs by increasing the reservoir pressure, with the water and/or gas displacing oil from the pore spaces. Waterflooding and/or gas flooding may be used in primary or secondary production from the field, and the efficacy of waterflooding depends in part on the compatibility of the injected water and/or gas with the reservoir's connate water and/or other factors such as the interaction of the injected water and/or gas with the reservoir rock. It is also desired to not introduce oxygen, bacteria, and undesirable chemicals into the reservoir via injection water. In the method of the invention, at least one treatment system such as a demulsification system is provided with at least one plasma reactor system at the site of a waterflooding and/or gas flooding operation in an oil field at 160. A crude oil emulsion is pumped from one or more production wells in the oil field to the plasma reactor system at 162. The crude oil emulsion is plasma treated at 164 in the reactor system to form crude oil, plasma enhanced treatment water and gas(es) and solids constituents. The separated constituents are removed from the reactor system and supplied to a retention tank at 166. After a predetermined or controlled retention time, the separated crude oil and plasma enhanced treatment water are removed from the retention tank at 168, and the plasma enhanced water and/or plasma enhanced gas(es) is supplied to an injection well in the waterflooding or gas flooding operation. The process is repeated at 170 to flush, remove and separate crude oil to a desired degree from the oil reservoir. In many oil fields, a plurality of wells are drilled to produce crude oil from the reservoir. In this or other methods, a plurality of production wells may supply crude oil emulsions to one or more distribution systems, such as a distribution manifold, to allow flow control of a stream of the oil emulsion to at least one demulsification system including at least one plasma reactor. In an example, a plurality of reactors in parallel or in series may be provided to receive a flow of the crude oil emulsion from the distribution system, such that depending on the characteristics of the emulsion, there can be multiple stages of reactors in series or parallel. It is also possible to operate reactors separately, such that depending on the characteristics of the emulsion, a first stage reactor may be used to initiate phase separation of the crude oil emulsion with a first flow rate, energy input, pressure and/or other operational characteristics, while a one or more further stages may use a different flow rate, energy input, pressure and/or other operational characteristics. As will be described below, The apparatus and systems may allow for the characteristics of the plasma to be modified to produce desired demulsification of an emulsion and/or generation of plasma enhanced treatment fluids. Such characteristics may include for example, the use of higher plasma density or energy, providing more spark gap generators, generating a more uniform plasma or other characteristics. The at least one plasma reactor may also be used with other equipment, including mechanical separators such as knock out drums, phase separators, desalters, settling tanks or the like, electrical treatment such as electrostatic grids, or thermal treatment equipment for example. Demulsifying chemicals or agents may be used if desired. By supplying the crude oil emulsion from each production well to a distribution system, a continuous demulsification process may thus be employed to treat the production from a plurality of wells simultaneously. After plasma demulsification in the at least one plasma reactor system, the separated constituents in the emulsion are removed from the reaction chamber, and may optionally be supplied to the retention system for a short retention time. In comparison to past requirements for crude oil emulsifications requiring days or months or settling time after demulsification treatments, settling times after plasma treatment may be significantly shorter. The separated crude oil and plasma enhanced treatment fluids, including plasma enhanced treatment water and/or gas(es) are recovered and the plasma enhanced treatment fluids may be pumped to a storage tank or suitably supplied to be pumped into an injection well in the oil field for example. The plasma enhanced treatment fluids should enhance oil recovery by the synthesized surfactants and demulsification molecules formed during plasma treatment of the emulsion, and removes bacteria or other microbes and may have anti-microbial properties.

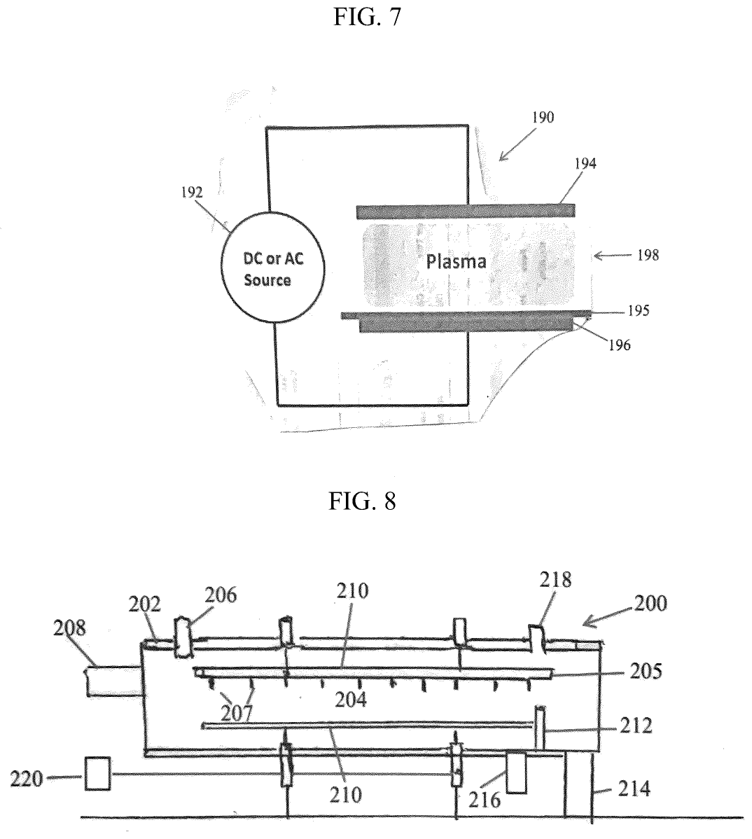

Turning to FIG. 7, an example of a plasma reactor for use in a demulsifying apparatus or system according to the invention is shown. As seen in FIG. 7, the plasma reactor 190 includes a power source 192, being either a DC or AC high or low voltage source. The voltage source 192 is connected to at least a first and second electrode 194 and 196, which define a spark gap 198 between them. The electrodes may be plates 194 and 196 for example. A plurality of plates may be stacked in a spaced apart arrangement. A high resistivity material, schematically depicted at 195 may be disposed on or between the electrodes 194 and 196. Upon application of a voltage to the electrodes, the carrier gas disposed in the spark gap or interelectrode space 198 is ionized to produce plasma in the interelectrode space 198. This type of plasma reactor is referred to as a resistive barrier discharge type, being a low temperature plasma source that operates at atmospheric pressure. With either AC or DC voltage sources, the discharge current generally exhibits a series of pulses, but other arrangements may be used. The current pulses may be a few microseconds wide and occur at a repetition rate of few tens of kHz for example, but again other arrangements may be used. A suitable power supply and operational characteristics may be provided and configured to generate the spark discharge in the inter-electrode discharge gap. As noted above, other types of plasma generators may be used, such as dielectric barrier discharge, a piezoelectric direct discharge, a glow discharge, gliding arc discharge, microwave plasma generation, pulsed discharges, spark discharges, corona discharges, a plasma pencil, a plasma needle, a plasma jet or other suitable techniques. Other techniques of generating the plasma may thus require a corresponding alternative reactor design as will be understood by those skilled in the art.

In a further example, this type of reactor is formed in a modular configuration, such as shown in FIG. 8. A modular reactor 200 includes a reactor body 202 defining a reaction chamber 204. The reaction chamber includes at least one gas inlet 206 for supplying at least one carrier gas into the reaction chamber 204. An emulsion or slurry inlet 208 is provided to introduce an emulsion or slurry into the reaction chamber 204. At least one pair of electrodes 210, such as upper and lower, are positioned to be exposed in the reaction chamber 204 in predetermined spaced apart relation. Electrodes 210 could also be positioned along the sides of the reaction chamber 204. To increase the treatment region of the plasma, a plurality of pairs of electrodes 210 may be provided in spaced relationship along the length and/or width of the reaction chamber 204 to generate plasma of a desired density in a predetermined volume of the reaction chamber 204. A power supply and control system 220 is provided to supply an AC or DC voltage to the at least one pair of electrodes 210, in a manner to ionize at least one carrier gas in the reaction chamber 204 and produce plasma in the reaction chamber 204 between the electrodes 210. As in FIG. 7, the modular reactor 200 may be considered a resistive barrier discharge (RBD) reactor, with plasma occurring between the upper and lower electrodes 210, from a high voltage side through the gas medium in the chamber 204. The electrodes 210 may be configured with either serving as anode or cathode in reactor 200 as may be desired. In operation, an emulsion is introduced into the reaction chamber 204 to a predetermined level, and the energy from the plasma interacts with the gas(es) in the headspace to create plasma enhanced treatment gas(es), and also contacts the surface of the emulsion and interacts with the emulsion at the interface as well as traveling through the emulsion where it finds ground at the other electrode 210. This resistive barrier discharge (RBD) type of reactor provides a low temperature plasma source that operates at atmospheric pressure, and again one of the advantages of this plasma source is that it can be operated using either DC or AC voltages. Plasma, as highly ionized gas, contains a significant number of electrically charged particles and is classified as the fourth state of matter. As plasma contains an equal number of free positive and negative charges, it is electrically neutral. The free positive and negative charges induce chemical reactions to produce new species and/or radicals, both in the gas(es) as well as liquids including the water and hydrocarbons in the emulsion. Different types of electric discharges can be used to produce plasma, such as in a continuous mode, or in a pulsed mode. Alternatively, a different power scheme may be used to generate the spark discharge. A variety of different pulse generators may be used to ignite the spark discharges. The plasma induces phase separation by efficiently dissipating energy into the water suspended in the crude oil emulsion due to the lower resistivity of the water, to react and deposit charge with and on to the water and emulsion to cause flocculation and coalescence of the water and produce synthesized surfactant and demulsification or other molecules from the mixture. When a nonconductive liquid such as crude oil contains a dispersed conductive liquid such as water, is subjected to plasma and an electrostatic field created thereby, various physical phenomena cause the conductive particles or droplets to combine. The water droplets become polarized and tend to align themselves with the lines of electric force, resulting in the positive and negative poles of the droplets being brought adjacent each other, causing coalescence. The water droplets may also be attracted to an electrode, causing coalescence. The electric field also distorts and thus weakens the interfacial film of emulsifier surrounding the water droplets, facilitating coalescence. The strong fields and charge deposition from the plasma also activate synthesized surfactant and demulsification molecules from the mixture, that relate to the ion species that are in solution with the water and/or gas(es)_in the emulsion or reactor. As such, the created plasma enhanced treatment fluids may be particularly useful in production operations in the same oil reservoir from which the treated emulsion came, and may be used in waterflooding or gas flooding operations as noted above for example. Alternatively, plasma enhanced treatment fluids may be useful for treating any other emulsions, such as oil emulsions from any other source, or different types of emulsions including gaseous emulsions. The ability to form plasma enhanced treatment fluids allows new revenue streams to be created while avoiding possible costs associated with such processes. Thus, the plasma treated water or water treatment fluids separated from the crude oil emulsion may be tailored for the particular environment in which the water is produced. The generated/synthesized surfactant and demulsifying molecules produced during plasma treatment of a crude oil, water, and methane gas mixture from a particular oil field may perform better than untreated water and provide enhanced separation of the constituents of the emulsion, reduced foaming or formation of a rag layer, and provide a reduction in retention time if needed for a particular emulsion. The production of the plasma enhanced treatment fluids, such as plasma enhanced treatment water and plasma enhanced treatment gas at the site also may allow elimination or reduction of added surfactant and water solutions during separation and/or in EOR operations using water or gas injection processes. As noted, the plasma enhanced treatment fluids may have enhanced wettability to facilitate oil recovery operations. The plasma enhance treatment fluids may also facilitate wastewater handling, treatment of foam or other gaseous emulsions or in other processes such as fracking operations.

In this example, at a position downstream of the reaction chamber 204, a separator 212 is positioned to separate the oil after demulsification. At least one outlet is provided to remove separated constituents from the reactor. In this example for an oil emulsion, an outlet 214 is provided at a point past the separator 212 for the separated oil, and an outlet 216 is provided to remove the separated water and solids constituents of the emulsion from the reaction chamber 204. Individual outlets for the separated water and solids constituents may also be provided. In this manner, after an emulsion is introduced via inlet 208, the separated constituents can be removed in a continuous manner. Alternatively, for a batch processing arrangement, only one inlet/outlet may be provided if desired. The separator 212 may be a weir, flume or other suitable separator. For example, separator 212 may be a weir plate designed to run the full width of the reaction chamber 204. This helps to minimize unwanted surges which would be deleterious to separation of the oil or cause water to overflow into the oil outlet compartment. The height of the weir plate may be adjustable, to adjust the static and operating levels of emulsion in the reaction chamber 204, and may allow for automatic adjustment based on changing conditions to further enhance and optimize performance of the system. The separator 212 may be operated to adjust and vary the height of the emulsion in the chamber 204 by any suitable mechanism.

In the example of FIG. 8, a plurality of pairs of electrodes 210 are in spaced apart relation along the length and/or width of the chamber 204 to produce multiple spark gaps along the length and/or width of the reaction chamber. The reactor 200 may be configured with a predetermined number of electrical discharge electrode pairs in a modular system, with additional modular reactors able to be used in conjunction with one another in parallel or series to process emulsions or slurries. Modular reactors 200 can be easily assembled to work either independently or work together within a particular or existing processing system as a step in handling the emulsion. The number of reactors 200 can be varied easily according to the production requirement. Each reactor 200 can be operated independently using its own flow control, pressure control and power supply control, or a plurality of reactors can be operated together. Alternatively, a reactor 200 may be configured to have a larger number of electrical discharge electrode pairs spaced along or widthwise in the reactor, designed to accommodate a particular flow rate or volume of emulsion based on a particular application for example. A gas inlet valve 206 is provided to introduce a carrier gas into the space created above an emulsion introduced into chamber 204 to a predetermined level. The gas may be any suitable gas that will produce a plasma in the plasma chamber 204. Exemplary carrier gases include, but are not limited to, helium, neon, argon, xenon, and hydrogen, among other gases. The carrier gas may also be a hydrogen-containing gas, such as, but not limited to, water, steam, pure hydrogen, methane, natural gas or other gaseous hydrocarbons. Mixtures of any two or more such hydrogen-containing gases or other suitable gases may be used.

In this example of a reactor 200, a non-thermal plasma is generated at about atmospheric pressure in the chamber 204 to create a plasma zone in reactor 200. The emulsion is made to flow through the plasma zone in the chamber 204 and into the inter-electrode gap within the chamber 204. An applied voltage between the electrodes which is equal to or greater than the breakdown voltage of the carrier gas in the inter-electrode discharge gap generates plasma. The current between the electrodes at a voltage potential sufficient to cause a spark discharge and the plasma zone in chamber 204.

In an example, for a crude oil emulsion, methane gas or natural gas may be available at the site of the emulsion to be processed and can be used as the carrier gas in the reactor 200. The use of methane, as a non-oxidative gas, may allow higher energy input in operation of the reactor 200. The carrier gas may also be a flue gas from a nearby source or any other suitable gas or source. In the modular system, it may also be worthwhile to use the carrier gas from one modular reactor in other reactors that may be in use in an overall system, as well as the plasma enhanced treatment water produced. Alternatively, the plasma enhanced treatment gas can be recirculated from an outlet valve 218, to facilitate continued formation of the synthesized surfactants and demulsification molecules in association with the water and other gases in the emulsion. The carrier gas may be supplied to form a slightly pressurized reaction chamber 204 during operation.

In this example, the at least pair of electrodes 210 include an upper electrode and lower electrode that each project into the discharge chamber 204, and define an inter-electrode discharge gap. The inter-electrode discharge gap can be adjustable and set to optimize desired plasma generation. The electrodes 210 are connected to a power supply and control system 220 (shown schematically), to allow electrodes 210 to be energized to a varying voltage potential difference between electrodes sufficient to ionize the carrier gas and create plasma. In an example, an operating voltage of 1-60 kV with a current of 0.1 to 4 mA may be provided for example, but the operating voltage and/or current may be set in any desired manner to achieve plasma formation, and may vary dependent on the inter-electrode discharge gap, emulsion characteristics, density of the medium or other factors. Insulation or other suitable arrangements to prevent unwanted discharges may be provided. The power of the plasma generated in the reactor 200 may depend on the required production rate and specific energy input to the treated emulsion to achieve the desired results from a particular reactor 200 in association with a particular emulsion. Different reactors 200 in a modular system can be operated differently to achieve the desired results. The use of higher voltages and/or currents to control plasma generation may enhance mobility of the constituents in the emulsion, and/or the use of higher currents may provide more water extraction. The energy of the plasma may be controlled to adjust for particular characteristics of the emulsion or other factors. The plasma caused flocculation and coalescence allow extraction of water at lower initial currents and voltages because the plasma produces resistive and/or conductive pathways for charge species, differently charged ions and electrons in the emulsion. The plasma energy it thus transferred to and through the emulsion and gases and liquids therein, creating additional reactive species or molecules to produce the plasma enhanced treatment fluids with the enhanced characteristics. The inter-electrode discharge gap, and plasma energy is designed to optimize the efficiency of the demulsification process, and may be based on factors such as the emulsion being treated, the injected carrier gas, and the applied voltage and/or current or other factors. For example, the inter-electrode discharge gap may be from 1 to about 100 millimeters, but can vary. The energization of the electrode may be equal to, or greater than, the breakdown voltage of the carrier gas, which may vary depending on various factors and conditions in the reactor. The dielectric breakdown of the carrier gas varies according to the particular gas(es), the gas pressure, density of the reactor medium, the geometry of the electrode, the inter-electrode distance and/or other factors, and the voltage applied to the electrodes may be varied accordingly to produce desired plasma energy and/or density. The breakdown voltage of the carrier gas will be less than the breakdown voltage of the emulsion or separated liquids produced, providing a large surface area in reaction chamber 204 of direct contact between the plasma discharge and emulsion, and pathways therethrough. The discharge occurs between the electrodes 210 in association with the carrier gas and moves through the emulsion to ground at the other electrode 210. Depending on the arrangement, the discharge may be continuous or pulsed. The power supply and control system 220 required will depend on the number of electrode pair gaps for processing of an emulsion, the inter-electrode discharge gap, the continuous energy requirements or pulse repetition rate, emulsion flow rate through the reactor, the gas flow in the chamber or other factors for example.

At least one control system 220 may be provided to operate the various systems or functions of the apparatus 200 or parts thereof. The control system 220 may be a suitable computer control for example, including a computing device that may comprise one or more processor(s), PLC controllers or any other suitable system, configured to execute computer-executable instructions, such as instructions composing operation of one or more components of the reactor 200 and/or modular reactors as a part of a system. A computer typically includes a variety of computer readable media and can be any available media that can be accessed by computer. The system memory may include computer storage media in the form of volatile and/or nonvolatile memory such as read only memory (ROM) and/or random access memory (RAM). By way of example, and not limitation, there may be provided an operating system, application programs, other program modules, and program data. A user or operator is enabled to enter commands and information into the computer. In this example, the control system 220 may include a suitable interface to allow setting and selection of operation of the reactor(s) 200 and/or other associated systems. The control may thus operate the power supply, the pumps for supply and/or extraction of emulsion or constituents, drives for adjusting the separator such as a weir, adjusting the inter-electrode gap, controlling the gas injection and circulation, removal device for any solids constituents or other equipment or components as described, which may be performed by an unskilled operator. The control system 220 may include the use of sensors to monitor all aspects of operation of the reactor(s) 200, such as level sensors, pressure sensors, flow sensors, temperature sensors or any other suitable sensor for monitoring operating functions of the reactor(s) 200.

In an example, the treatment of an emulsion would be performed as a continuous process in the reactor system for an emulsion or slurry. The emulsion or slurry is supplied to the reactor 200 to predetermined height controlled by the control system 220. The emulsion is made to flow through the reactor chamber 204 at a predetermined flow rate continuously at a predetermined or variable rate controlled by the control system 220. The rate corresponds with the demulsification characteristics in association with a particular emulsion, the configuration of the modular reactor system or reactor 200, or other factors. The flow rate will determine the dwell time the emulsion interacts with the plasma to result in demulsification to a desired degree. The emulsion may be recirculated to continue plasma treatment for a predetermined energy input to the emulsion or treatment time for the particular emulsion. The separated constituents are then continuously removed from the reactor 200 or modular reactor system after separation. Alternatively, in batch process, the reactor 200 may be designed to accommodate a volume of emulsion and expose the volume to plasma for a dwell time in a similar manner, with the demulsified constituents removed thereafter.

In this example, the electrodes 210 are connected to a power source to supply AC or DC voltage to between the electrodes 210 which pass through the reactor body 202, and connect to one or more conductive sheets or plates 205. A plurality of plates 205 may be used in association with one or both electrodes in spaced apart relation for example. The electrodes 210 or one or more plates 205 may be provided with a resistive material, such as a coating or otherwise, to facilitate plasma generation. The electrical power for generating plasma between the select pairs of electrodes 210 may be less than 20 kW, such as from about 100 W to about 10 kW for example, but other power supplies may be used. The sheets 205 may be provided with several pins or points 207 extending toward the other electrode 210 if desired. The pins 207 may be attached or formed with plates 205 to extend toward the other electrode. In operation, plasma will be generated and discharge into the circulated gas to the surface of the emulsion flowing or provided in the reactor 200. The lower (and upper) sheets 205 may be mesh to allow solids in the emulsion to settle toward the bottom of chamber 204. The position of the upper and lower plates or sheets 205 are variable, and may be modified based on different expected heights of the emulsion as controlled, to provide optimized conditions for treatment and demulsification. Any suitable arrangement for varying the position of plates 205 or electrodes 210 may be used. The sheets 205 may also have plasma catalytic properties. The sheets 205 in association with lower electrodes 210 may also be configured to promote separation of the constituents as they are separated as the emulsion flows through the reactor, as well as the bottom and/or sides of the reactor body 202. The lower electrodes 210 designed for submersion in the emulsion may be configured accordingly. The emulsion as it is demulsified will separate into a layer of oil at the top, a rag layer of oil/water still mixed and a bottom layer of water with any solids falling out to the bottom. A system for moving any settled solids toward outlet 216, such as a conveyor system or other suitable arrangement may be provided.

Other design and/or operational alternatives may be provided, such as for example, the plasma energy or density is constant or varied along the length of the reactor chamber 204. The inter-electrode discharge gap may be constant or varied along the length or width of the reaction chamber. For example, as constituents are separated towards the outlet of the reactor chamber 204, the configuration may be altered accordingly. The electrode configurations may facilitate production of a more uniform plasma within the reactor chamber 204 above and in interaction with the emulsion in the chamber 204, but alternative electrode configurations or other characteristics of reactor 200 are contemplated, and would be evident to a person of ordinary skill in association with plasma reactors. For example, the electrodes 210 may be shaped as flat sheet or blade electrodes, and/or as tube-shaped electrodes or in other suitable forms. Again, different configurations of plasma reactor may be used to treat an emulsion according to the invention.

The modular reactor 200 may thus be easily transported and deployed at the source site of an emulsion, such as oil production wells. An oil field generally will include a plurality of oil production wells, and the modular demulsification system 200 may be configured with other systems 200 to handle a group of production wells. All the crude oil emulsions produced from each well would flow into at least one demulsification system 200 for phase separation, as will be described in relation to a further example. The ability to easily transport and deploy one or more modular demulsification systems 200, that can be mounted on a base, such as a pallet, allow for any number of reactors 200 used to accommodate a particular source of emulsion. The modular demulsification system 200 also allows the methods as described to be easily implemented, such as to assist in cleaning up a crude oil spills in water or land, such as from underwater pipelines, well blowouts, barge accidents or otherwise. At the location of such a spill, a slurry pump or the like may be used to gather the oil/water emulsion from the water and supply it to one or more demulsification systems 200. After demulsification, the oil can be salvaged, and supplied to an oil barge or other suitable storage, while the water is storable for further processing if needed. The use of one or more demulsification systems 200 aboard a vessel would be easily implemented for remediation of such spills, and reduce the environmental impact. Similarly, the invention could be used in clean up of oil from beaches or soil affected by a spill, with the contaminated sand or soil formed into a slurry with water, and supplied to one or more demulsification systems 200. Heavy oil sands may also be produced in a similar manner. One or more demulsification systems 200 may be used to demulsify a rag layer for recovery of additional crude oil that is not generally cost effective to recover.

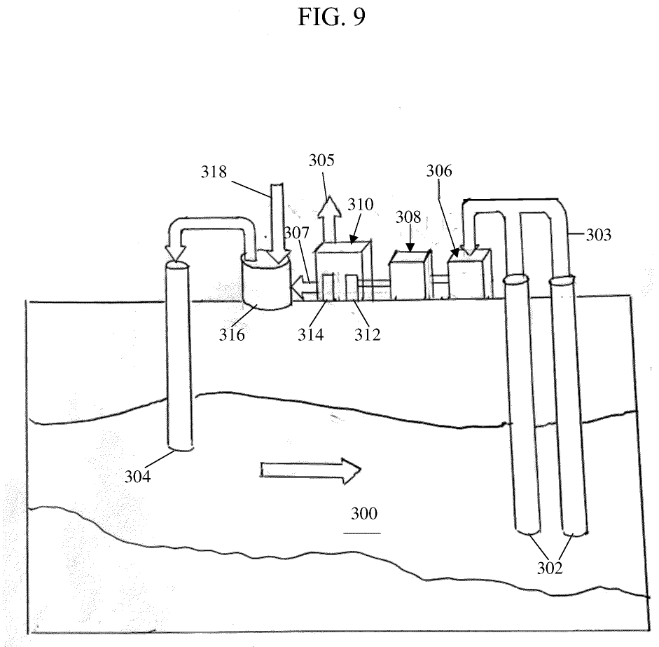

An example system for recovery of crude oil from an oil reservoir is shown in FIG. 9. The oil reservoir 300 has a plurality of production wells 302 drilled into it, as well as at least one or a plurality of injection wells 304 for the injection of water. In many oil fields, further oil production is facilitated by waterflooding, in which water is pumped into the ground in an oil field through an injection well. The pumping of water increases the production from oil reservoir by increasing the reservoir pressure, with the water displacing oil from the pore spaces. Waterflooding may be used in primary or secondary production from the field, and the efficacy of waterflooding depends in part on the compatibility of the injected water with the reservoir's connate water and/or other factors such as the interaction of the injected water with the reservoir rock. In the system, the production from the plurality of production wells 302, being an emulsion of crude oil 303, water and solids, is supplied to a distribution system 306. The distribution system 306 may be positioned to receive the crude oil emulsion of a plurality of production wells 302, and may be optionally used in association with other equipment 308 such as mechanical separators such as knock out drums, phase separators, desalters or the like, electrical treatment such as electrostatic grids, thermal treatment equipment and/or settling or retention tank for example. Such additional equipment 308 may be optionally used depending on the unique characteristics of a particular oil reservoir and crude oil emulsion, and may situated before or after the distribution system 306. The distribution system 306 is controlled to supply a predetermined volume of crude oil emulsion 303 to a demulsification system 310 according to the invention, or to the other equipment 308 if used, and then supplied to the demulsification system 310 in a controlled manner. The crude oil emulsion 303 is supplied to one or more plasma reactors 312 as a part of the demulsification system 310.

These may be modular plasma reactors 312 that can easily used in conjunction with one another to provide the desired configuration of a demulsifying system 310. The modular reactors 312 may be provided as relatively small, modular systems allowing easy transport and positioning in relation to a source of emulsion, and require low maintenance. Modular reactors 312 can be easily assembled to work either independently or work together within a particular or existing processing system as a step in handling the emulsion 303. The number of reactors 312 can be varied easily according to the production requirement. Each reactor 312 can be operated independently using its own flow control, pressure control, power supply control and the like, or a plurality of reactors can be operated together by a common control system. Alternatively, a reactor 312 may be particularly configured and designed to accommodate a particular flow rate or volume of emulsion based on a particular application for example. In this example, the demulsification system may be relatively easily implemented at the site of a waterflood operation for an oil reservoir 300. The crude oil emulsion is plasma treated with the at least one plasma reactor 312 in the demulsification system to form crude oil, water and solids constituents. The separated constituents are removed from the at least one plasma reactor system and supplied to a retention tank 314 if needed for a short retention time after processing. A continuous flow of the crude oil emulsion 303 may be supplied to the demulsification system 310 for processing, or batch processing may be used. After processing in the demulsification system, the separated crude oil 305 is supplied for sale, and the plasma enhanced treatment fluids 307, such as plasma enhanced treatment water and/or plasma enhanced treatment gas is supplied to at least one storage tank 316 for an injection well 304 in the waterflooding operation. If needed, make up water 318 may be supplied for waterflooding using the plasma enhanced treatment water from demulsification system 310. A plasma enhanced treatment gas from demulsification system 310 may be used in injection for gas flooding or pumped to another location for use, such as in further demulsification processes in demulsification system 310 or other demulsification system, a gas lifting operation or any other process. The plasma enhanced treatment fluids may allow enhanced recovery while requiring reduced injection pressure and pressure in the formation. Depending on the particular oil field, the ability to supply production from a plurality of wells to the demulsification system 310 through the distribution system 306 allows significant flexibility in designing the demulsification system 310 for a predetermined flow rate and volume for processing in a particular situation. The demulsification system can be optimized to enhance production of crude oil for a particular oil field. The use of one or more distribution systems 306, such as a distribution manifold to accommodate the predetermined or expected production of crude oil emulsion, allows flow control of the oil emulsion 303 to the at least one plasma reactor 312. The at least one reactor 312 may be used to treat an amount of emulsion and to recirculate the emulsion for additional treatment until a desired energy input and/or separation of constituents is achieved if desired. Alternatively or in addition, a plurality of reactors in parallel or in series may be provided to receive the flow of the crude oil emulsion 303 from the distribution system 306, and may be operated separately or as a unit. The ability to treat the production from a plurality of wells simultaneously may provide cost efficiencies. The provision of plasma enhanced treatment fluids back into the at least one injection well 302 should enhance oil recovery by the synthesized surfactants and demulsification molecules formed during plasma treatment of the emulsion. The demulsification system 310 and plasma reactor 312 also facilitate removing bacteria or other microbes and may have anti-microbial properties when reinjected into the oil reservoir 300 to help prevent souring of the reservoir.

The demulsification system 310 phase separates severe emulsions of crude oil and water, to minimize any rag layer, leading to additional revenue. The demulsification system 310 further allows the operator to continuously produce crude oil and sell it quickly for increased revenue with little or no retention time. The ability to integrate with waterflooding during enhanced oil recovery (EOR) provides significant advantages in relation to traditional methods of phase separation of heavy crude oils, oil sands or the like for example. The ability to transport and employ a demulsification system 310 at or close to the site of the source of emulsion allows for transportation and production efficiencies. The demulsification system 310 may also include a reactor 312 for processing rag layer specifically, in a primary or later demulsification process. Any rag layer remaining after processing can be separated for further demulsified for recovery of additional crude oil that has previously not been cost effective to recover.

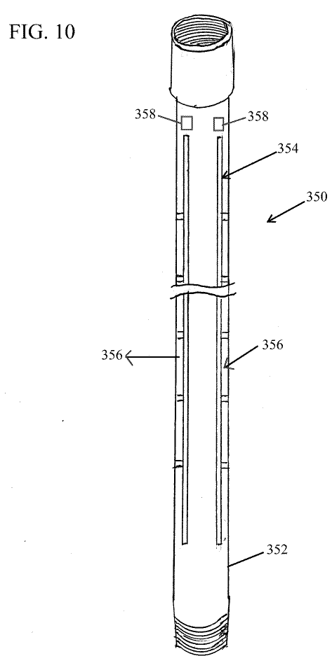

Turning now to FIG. 10, there is shown a schematic of a demulsification system 350, provided in association with downhole casing or tubing for example, for processing of a crude oil emulsion as it is produced from a well. In this example, a demulsification system 350 is formed with a body 352 to replace a section of standard industry production tubing or casing, allowing one or more to be included downhole as a part of the production tubing string of a production well. The body 352 allows a crude oil emulsion to enter and flow through it just as with a standard length of production tubing. The demulsification system 350 includes at least one plasma reactor 354 along the length. The plasma reactor may have at least first and second electrode assembly 356 in spaced position along the width or circumference of body 352, such that the crude oil emulsion flows through the space between electrode assemblies 356 as it is pumped to the surface. The inter-electrode discharge gap is selected to provide plasmatic discharge or plasma when electric current is conducted to the electrode assemblies 356 via resistive and/or conductive paths through the emulsion. The electric current may be conducted into at least one of the electrodes to generate spark discharges to generate. The electrical power for generating plasma between one or more pairs of electrodes 356 may be less than 20 kW, such as from about 100 W to about 10 kW) for example, but any suitable energy is contemplated. The plasma may be generated continuously or pulsed. The electrodes 356 may be formed as plates or sheets similar to previously described, or may be of any suitable configuration, such a tubular or cannulated. The crude oil emulsion will typically include natural gas or methane that the high voltage electrodes will ionize to form plasma and phase separate the emulsion as it flows through the electrodes 356. Additional carrier gas may be supplied at the location of the electrodes 356 to facilitate plasma production, such as by a carrier gas supply system 357. The gas supply system 357 may be any suitable arrangement to introduce gas into the space around and/or between the electrodes 356 for example. The system 350 may be supplied with a carrier gas using gas manifolds arranged along the length to introduce the carrier gas as desired locations. The system may also be used in conjunction with an artificial lift operation for example, where similar gas manifolds and valving are used to inject gas and lift the fluids in the production tubing. A carrier gas may be injected into the crude oil emulsion flowing between the electrodes 356 at locations to facilitate plasma generation. A control and power system for the at least one plasma reactor 354 may be integrated into the demulsification system 350, and coupled to a power source at the well head that supplies power to the downhole completion equipment for example. Other suitable arrangements to provide power to the at least one plasma reactor 354 may be used, such as a battery supply. The demulsification system 350 phase separates the crude oil emulsion into constituents that can be separated downstream, such as at the well head for example. The operator may use a plurality of these modular demulsification systems 350 along the length of the downhole tubing to demulsify the crude oil emulsion. Alternatively, a demulsification system including at least one plasma reactor may be provided at the bottom of the production well at the location where the crude oil emulsion enters the production tubing for example. Such demulsification systems 350 may be used in conjunction with another demulsification system at the well head or other downstream location and/or in association with other equipment such as mechanical separators, phase separators, desalters, settling tanks or the like, electrostatic grids, or thermal treatment equipment for example.

While specific examples of the invention have been described in detail, it will be appreciated by those skilled in the art that various modifications and alternatives to those details are contemplated in the invention. These examples are thus meant to be illustrative only and not limiting as to the scope of the invention as set forth in the appended claims and any and all equivalents thereof.

What is claimed is:

1. A method for demulsification of an emulsion, comprising
providing at least one demulsification system including at least one plasma reactor with at least one first and second electrode exposed in a reaction chamber defining an inter-electrode discharge gap therebetween, introducing at least one carrier gas into the reaction chamber and a volume of emulsion, energizing the at least first and second electrodes at or in excess of the dielectric breakdown voltage of the at least one carrier gas to generate plasma in the reaction chamber to demulsify the emulsion into constituents, and removing the separated constituents from the reaction chamber.

2. The method according to claim 1, wherein the emulsion is a crude oil emulsion, and the constituents are at least water and oil.

3. The method according to claim 2, wherein the at least one demulsification system is located at an oil field and the crude oil emulsion is supplied from at least one production well in the oil field.

4. The method according to claim 3, wherein the crude oil emulsion is supplied from a plurality of production wells in the oil field through at least one distribution system.

5. The method according to claim 3, wherein the at least one carrier gas is a gas produced along with the crude oil emulsion.

6. The method according to claim 1, wherein the emulsion is continuously or intermittently supplied to the at least one demulsification system and the separated constituents continuously or intermittently removed from the reaction chamber.

7. The method according to claim 1, wherein the demulsification system includes a plurality of plasma reactors operating in conjunction to phase separate the emulsion.

8. The method according to claim 7, wherein the plurality of plasma reactors operate in series or parallel with one another.

9. The method according to claim 2, wherein the source of the crude oil emulsion is a crude oil spill, oil sands or oil in sand/soil formed into a slurry or a rag layer, which are supplied to the at least one demulsification system.

10. The method according to claim 1, wherein the at least one carrier gas is recirculated to the reaction chamber.

11. The method according to claim 1, wherein the generation of plasma in the reaction chamber generates plasma enhanced treatment fluids with synthesized surfactant and demulsification molecules.

12. The method according to claim 10, wherein the plasma enhanced treatment fluids are supplied for use in oil recovery or production processes.

13. A demulsification system, comprising
at least one plasma reactor with a body forming a reaction chamber and at least one first and second electrode exposed in the reaction chamber defining an inter-electrode discharge gap therebetween, a gas inlet for introducing at least one carrier gas into the reaction chamber, a port for introducing a volume of emulsion into the reaction chamber, and a control system and power supply energizing the at least first and second electrodes at or in excess of the dielectric breakdown voltage of the at least one carrier gas to generate plasma in the reaction chamber to demulsify the emulsion introduced into the reaction chamber into constituents, and a port for removing the separated constituents from the reaction chamber.

14. The demulsification system of claim 13, wherein the demulsification system includes a plurality of plasma reactors.

15. The demulsification system of claim 13, wherein the at least one plasma reactor has a plurality of first and second electrodes at spaced positions in the reaction chamber to generate plasma in a predetermined volume of the reaction chamber.

16. The demulsification system of claim 13, wherein the inter-electrode discharge gap is variable.

17. The demulsification system of claim 13, wherein a separator is provided to separate at least one constituent of the emulsion after phase separation.

18. The demulsification system of claim 13, wherein the demulsification system includes a plurality of modular plasma reactors operating in conjunction with one another, and wherein the number of modular reactors accommodates a predetermined flow rate of emulsion.

19. A method of producing plasma enhanced treatment fluids for oil recovery, comprising providing at least one plasma reactor with at least one first and second electrode exposed in a reaction chamber defining an inter-electrode discharge gap therebetween, introducing an oil emulsion and at least one carrier gas into the reaction chamber, energizing the at least first and second electrodes at or in excess of the dielectric breakdown voltage of the at least one carrier gas to generate plasma in the reaction chamber to generate plasma enhanced treatment fluids, and removing the plasma enhanced treatment fluids from the reaction chamber.

20. The method of claim 19, wherein oil emulsion is provided from at least one production well in an oil reservoir to the at least one plasma reactor and the generated plasma enhanced treatment fluids include plasma enhanced treatment water and/or plasma enhanced treatment gas(es) that is removed from the reaction chamber and introduced into at least one other process for oil recovery from the oil reservoir.
